(19) United States
(12) Patent Application Publication
(10) Pub. No.: US 2008/0115641 A1
(43) Pub. Date: May 22, 2008

(54) DEVICE FOR LONGITUDINALLY CUTTING A CONTINUOUSLY CONVEYED WIDTH OF MATERIAL IN ORDER TO FORM A STRIP WITH A VARIABLE LONGITUDINAL PROFILE

(75) Inventors: Hubert FREYBURGER, Colmar (FR); Thierry FREBOURG, Labaroche (FR)

Correspondence Address: DAVIS BUJOLD & Daniels, P.L.L.C., 112 PLEASANT STREET, CONCORD, NH, 03301, US

(73) Assignee: MEGASPIREA PRODUCTION, Colmar (FR)

(21) Appl. No.: 12/019,806

(22) Filed: Jan. 25, 2008

Related U.S. Application Data
(60) Provisional application No. 60/898,572, filed on Jan. 31, 2007.

(30) Foreign Application Priority Data
Jul. 25, 2005 (FR) 05/07878

(51) Int. Cl. B26D 7/06

(52) U.S. Cl. 83/425.2; 83/428; 83/100

(57) ABSTRACT

The invention concerns a device for cutting, from a width of continuously conveyed material, a variable longitudinal profile in a controlled, irregular sequence, which nevertheless remains a simple, economical, easily implemented and configured device responsive to high speed production requirements. The cutting device has a pair of cutting tools cooperating with an elongate counter-cylinder extending perpendicular to the direction the width of material is conveyed. The cutting tools are movable along two axes from the frame: a rotational axis, perpendicular to the counter-cylinder so as to modify the cutting angle of each cutting tool, and a translational axis parallel to the counter-cylinder so as to modify the distance between the cutting tools. Each cutting tool is connected with a rotational and a translational drive mechanism which are controlled by a central processing unit according to a cutting line with a variable profile and in a given irregular sequence.

### TECHNICAL FIELD

The present invention concerns a device for longitudinally cutting a width of material that is being continuously conveyed, especially paper or a similar material, in order to cut out at least one strip with a variable longitudinal profile in an irregular sequence, the device comprising at least a first pair of cutting tools cooperating with at least one counter-piece disposed perpendicular to the direction in which the width of material is moving, at least one frame on which the cutting tools are mounted so as to move on a translational axis parallel to the counter-piece, thereby modifying the interval between the two cutting tools, and on a rotational axis perpendicular to the counter-piece, thereby modifying the cutting angle.

### PRIOR ART

Devices for cutting a continuously conveyed width of material are well known in the paper industry, for example, in mail preparation machines using devices for cutting either envelopes or documents to be inserted inside envelopes. In all these cases, the documents to be cut from a single width of paper are identical, with a regular shape and cutting path. Consequently, the cutting tool is formed of a cutting blade mounted on a rotating cylinder, which allows at least one profile or shape to be cut from the continuously moving width of paper, the profile or the shape being identically and cyclically replicated. This type of cutting tool does not permit the cutting of variably irregular shapes or profiles that do not follow a reproducible sequence.

Publication GB-702 116 describes another cutting device comprising two points or small wheels located on either side of the width of paper, each of which is attached to the end of an oscillating arm that is laterally displaceable in order to cut the borders of the width of paper into a non-rectilinear profile. The lateral displacement of each cutting tool is effected by a drive finger connected to the oscillating arm and guided along the profile of a cam located in a rotating cylinder. The cut profile obtained through the use of this device is also cyclical, as the cutting tools follow an identical trajectory each time the cylinder rotates.

U.S. Pat. No. 5,918,519 describes yet another cutting device comprising two circular blades cooperating with a counter-piece, attached to a transversely movable trolley and supported by a beam movable around a pendulum axis located at a distance from the cutting point of the blades so that the cutting point describes a circular arc when the blades are displaced transversely and generates an irregular, non-rectilinear cut profile. However, it is not possible to control angular displacement of the cutting devices, since it is produced only when the knives are displaced transversely. For this reason, the cut profile obtained is not controlled.

Cutting devices known in the art are not satisfactory because they do not allow cutting a shape with a variable longitudinal profile in an irregular sequence that is totally controlled.

### DESCRIPTION OF THE INVENTION

The aim of the present invention is to overcome these disadvantages by proposing a device for cutting from a width of continuously conveyed material a variable longitudinal profile in a controlled, irregular sequence, which nevertheless remains a simple, economical, easily implemented and configured device responsive to high speed production requirements.

For this purpose, the invention concerns a cutting device of the type indicated in preamble, characterized in that each cutting tool is connected to a translational drive mechanism and a rotational drive mechanism, said mechanisms being controlled in combination by at least one central processor according to a cutting line with a variable longitudinal profile in a predetermined and controlled irregular sequence.

The cutting tools may be selected from the group comprising laser beams, ultrasound beams, streams of water, cutting points, or circular blades.

According to a variation, these cutting devices may comprise a second pair of cutting tools to cut from the same width of continuously conveyed material a second strip with a second variable longitudinal profile in a predetermined and controlled irregular sequence.

In the preferred embodiment, each cutting tool is mounted on a trolley moving in translation on the frame along at least one transverse guide, the trolley being connected to the translational drive mechanism.

The rotational drive mechanism advantageously comprises at least one actuator located on the movable trolley and connected with its cutting tool, either directly or through a mechanical transmission.

The cutting device may comprise at least one pressing mechanism for moving the cutting tools between at least a raised resting position in which the cutting tools are distanced from the counter-piece and a lowered working position in which the cutting tools are in pressured contact with the counter-piece.

In the preferred embodiment, the pressing mechanism comprises at least one cylinder located on the movable trolley and the cutting tool is supported by the shaft cylinder, or conversely, the shaft defining the rotational axis.

In a variation, the cutting tool may comprise a circular blade and a circular counter-blade, these blades being tangential in the cutting zone, held by a support, oscillating around the rotational axis and connected to the rotational drive mechanism. In this case the counter-piece advantageously comprises the circular counter-blade extending into a roller and driven in rotation on its axis by an actuator located on the oscillating support.

In the preferred form of embodiment, the translational drive mechanism comprises at least one actuator common to a pair of cutting tools and connected to the movable trolleys through a mechanical transmission which moves the movable trolleys in the reverse direction and synchronously.

The actuators may be selected from the group comprising motors, reduction motors, servomotors, cylinders, or electromagnets, and the mechanical transmissions may be selected from the group comprising gear mechanisms, rack and pinion mechanisms, endless screws with reverse threads or dual screws and nuts, rods, gears and rods.

In the preferred embodiment, the counter-piece comprises at least one cylinder that is rotationally movable about its axis.

The cutting device is advantageously completed with at least one automatic evacuation unit for removing waste resulting from the cutting, having at least one suction nozzle placed near each cutting tool and connected to a waste container by a pipeline of a central suction device.

### SUMMARY DESCRIPTION OF THE DRAWINGS

The advantages of the present invention will be more apparent from the following description of several exemplary embodiments provided as non-limiting examples, with reference to the attached drawings, wherein:

FIG. 1 is a schematic view of a cutting device according to the invention;

FIGS. 2A and 2B are overhead views of a cutting outline drawn on a width of paper to obtain one and two strips of cut paper, respectively;

FIG. 3 is a perspective view of the cutting device according to the invention;

FIG. 4 is a bottom view of the device of FIG. 3;

FIGS. 5A and 5B are a perspective and cross section, respectively, of a variation of the cutting device according to the invention;

FIGS. 5C, 5D, 5E and 5F are detailed perspective, front elevation, lateral elevation, and axial cross section views, respectively, of the cutting device shown in FIGS. 5A and 5B; and

FIGS. 6 through 8 are top views of the cutting device of FIG. 3 according to three other different embodiments.

### ILLUSTRATIONS OF THE INVENTION

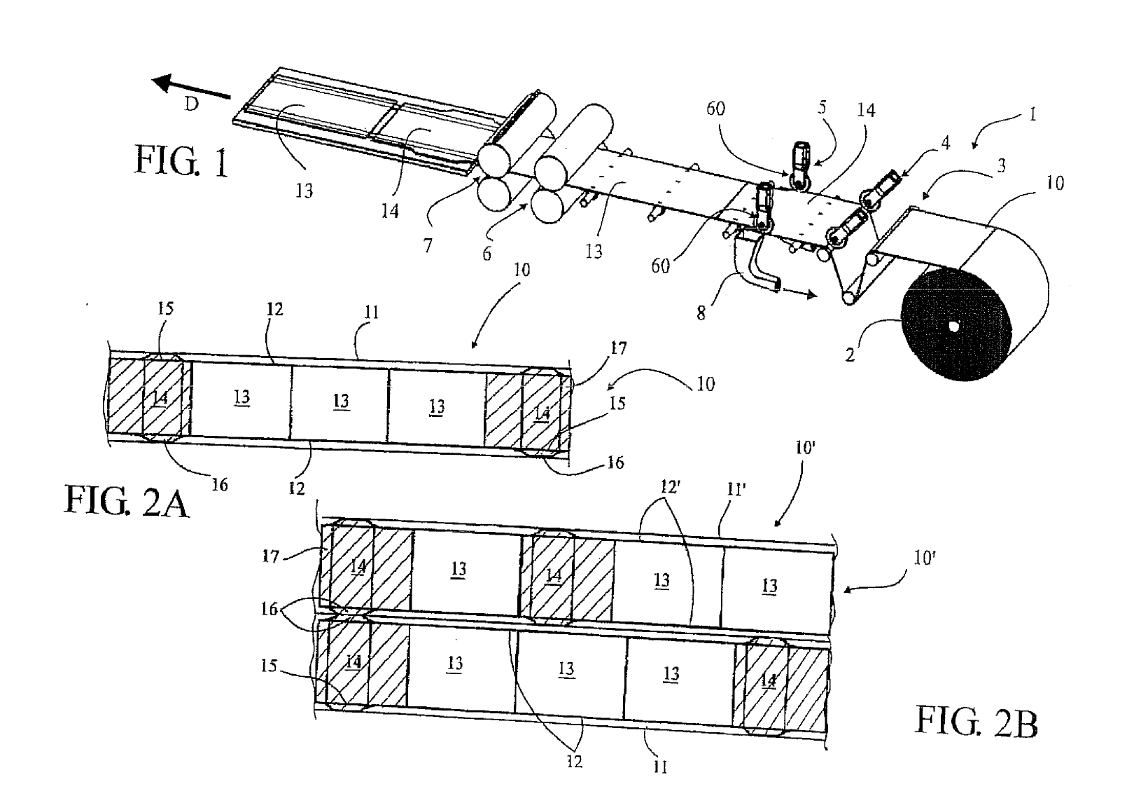

With reference to FIG. 1, the cutting device 5 according to the invention is applied to a mail preparation machine 1, only the cutting device portion of which is represented in this drawing. This mail preparation machine 1 is distinguished from conventional machines by the fact that the envelope 14 forms an integral part of the width of material 10, which in this case is a width of paper, from which the documents 13, to be enclosed, are printed and cut. This novel technique presents numerous advantages such as increased conveyance speed, improved mail security and integrity, as well as reduced cost per unit of mail.

For these reasons, this novel technique requires the use of a dynamic cutting device 5, the object of the present invention, designed to cut a strip 11 of paper from a width of paper 10 according to a controlled variable longitudinal profile 12 that is neither rectilinear or repetitive, such that the number and size of documents 13 and/or envelopes 14 may vary from one piece of mail to the next. FIG. 2A shows a first sample of a width of paper 10, from which a strip 11 is cut, comprising two envelopes 14 and three documents 13. FIG. 2B shows a second sample of a double width of paper 10; from which two strips 11, 11′ are cut each comprising two envelopes 14 and three documents 13, offset from one another, each strip 11, 11′ having its own profile 12, 12′. Obviously the cutting device 5 of the invention has applications in other industries requiring dynamic cutting of paper, textiles, plastics, metal and the like, and the width of material 10 may be a width of paper, cardboard, fabric, non-woven material, plastic film, metal, or the like.

With reference to FIG. 1, the width of paper 10 is unrolled from a preprinted spool supported on a reel 2. It may also originate directly from an on line printer. The width of paper 10 passes through a first roller support system 3 and then a grooving unit 4 for marking the crease 15 for the lateral flaps 16 on the envelopes 14, thus facilitating the folding operation. The width of paper 10 passes through the cutting device 5 shown, in this figure, only by its two cutting tools 60 and the suction nozzles 8 of the automatic waste evacuation unit. This cutting device 5 allows the longitudinal edges or margins of the width of paper 10 to be trimmed away forming a strip of paper 11 from which documents 13 are cut, to the correct width, and lateral flaps 16 of envelopes 14 are created, the latter exceeding the width of documents 13. The waste paper generated by this cutting device 5 is automatically evacuated by suction nozzles 8 and conducted to a storage container through a central suction line (not shown). The width of paper 10 follows along its course through a second roller support system 6, then a transverse cutting unit 7, which may use a rotating cylinder blade for separating the documents 13 from the envelopes 14 in order to feed a sorting and accumulation unit, and then a unit for folding and closing envelope 14 with its documents 13 (not shown). Transverse cutting unit 7 is controlled by a central processing unit (not shown) according to the formats of the envelopes and document to be cut, with the cut length of envelopes 14 being different from that of documents 13. This process may be controlled by a computer program that may or may not include a signal produced by sensors for detecting printed index marks on the width 10 or strip 11 of paper that identify the formats for cutting between documents 13 and envelopes 14.

Best Way to Achieve the Invention:

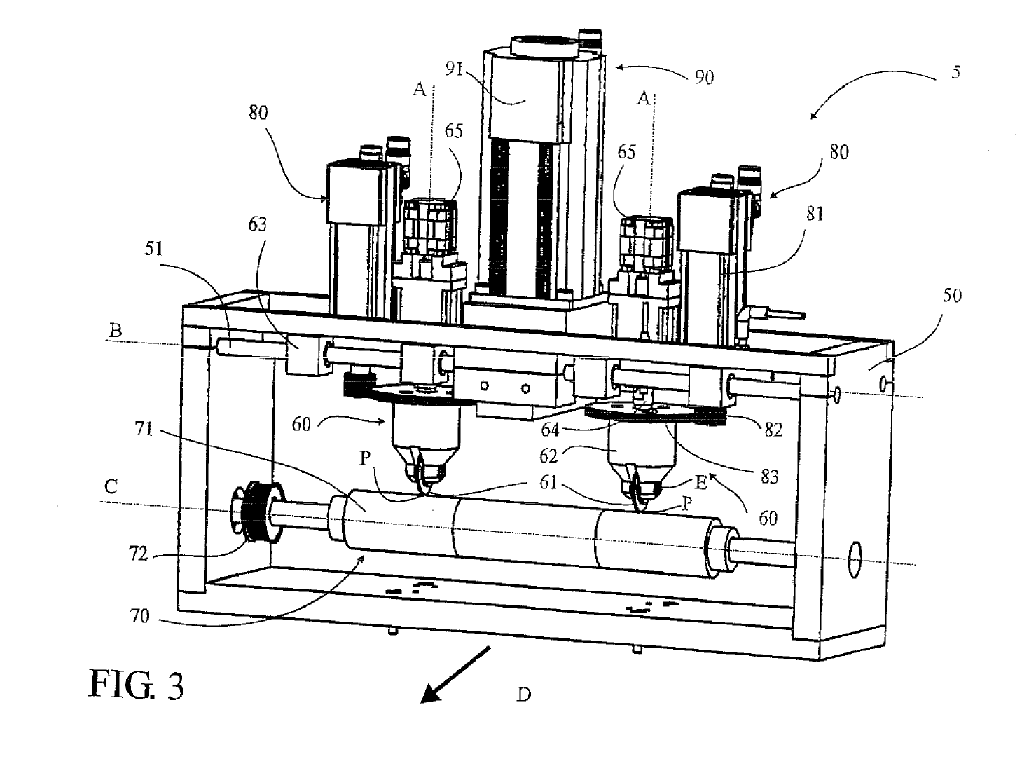

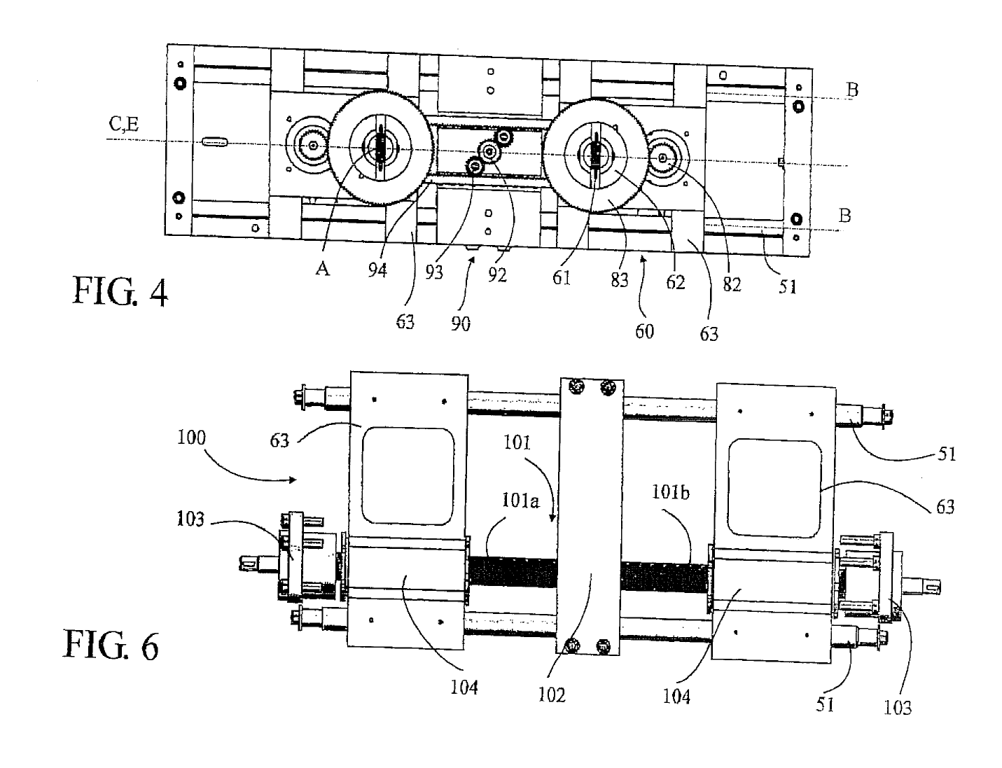

The cutting device 5 illustrated with reference to FIGS. 3 and 4 comprises a frame 50 that may be made mechanically welded, for example, and which supports at least a first pair of cutting tools 60 cooperating with at least one elongate counter-piece 70 disposed perpendicular to the direction in which the width of paper 10 is conveyed as shown by arrow D, with the width of paper 10 moving between cutting tools 60 and counter-piece 70 such that the longitudinal edges of the width of paper 10 are cut away to create the variable longitudinal profile 12 in a predetermined and controlled irregular sequence. To this end, cutting tools 60 are movable relative to frame 50 along two axes: a rotational axis A that is perpendicular to counter-piece 70 so as to modify the cutting angle of each cutting tool 60, and a translational axis B parallel to counter-piece 70 so as to modify the distance between the two cutting tools 60. In this example, each cutting tool 60 is connected to a rotational drive mechanism 80 and a translational drive mechanism 90 both controlled along the two rotational and translational axes in combination by a central processing unit (not shown) according to the predetermined variable profile 12 in irregular sequence.

Counter-piece 70 comprises a cylinder 71 positioned to rotate on its axis C relative to frame 50. Depending upon the application, this counter-piece 70 may, obviously, have a different shape and it may be fixed relative to frame 50. In this example, cylinder 71 is rotationally driven by a drive mechanism, of which only one pulley 72 is shown, and guided within bearings integral with lateral walls of frame 50 or some other equivalent means. The drive mechanism may consist of any type of actuator, connected either directly or through a mechanical transmission to the axis of counter-piece 70 and controlled by a central processing unit (not shown) according to the conveyance speed of width of paper 10. Cylinder 71 may be made of steel that is preferably harder quality than that of cutting tools 60, for example, equal to 63 HRC, obtained through thermal or chemical treatment or similar means.

In the example shown each cutting tool 60 comprises a circular blade 61 rotating on its axis E and rotationally driven by counter-piece 70, made of steel with a hardness equal to 61 HRC, for example, and mounted in a body 62. In this example, as axis A intersects with axis C and axis E intersects with axis A, contact point P of circular blade 61 on cylinder 71 is aligned on axis A. Obviously other configurations are possible. Body 62 is supported by a trolley 63 translationally movable relative to frame 50 along transverse guides 51 on axis B, using ball bearings or the like.

The rotational drive mechanism 80 for each cutting tool 60 is located on the corresponding movable trolley 63. In the example shown, it comprises a servomotor 81 connected with cutting tool 60 by a small pinion motor 82 engaging a large toothed gear 83 integral with body 62 to form a speed reduction gear. Body 62 is guided in rotation relative to movable trolley 63 on the extremity of a shaft 64 by means of ball bearings or the like. This shaft 64 is part of a pneumatic cylinder 65 or similar device located on movable trolley 63 forming a pressing mechanism for vertically displacing circular blade 61 between a raised resting position in which it does not contact counter-piece 70 and allows width of paper 10 to move along, and a lowered working position in which the blade 61 contacts counter-piece 70 with a certain amount of pressure used both to perform the cutting operation by pressing it and to compensate for wear on circular blade 61. Small pinion gear 82 is wider than large gear 83, allowing circular blade 61 to be vertically displaced between its resting and working positions while still remaining engaged. Obviously other pressing mechanisms could be used.

Translational drive mechanism 90 is common to both cutting tools 60 and in the example shown, it comprises a servomotor 91 connected to cutting tools 60 through a small pinion motor 92 engaging two diametrically opposed small gears 93, each of which engages a rack 94 integral with a movable trolley 63 to synchronously displace movable trolleys 63 translationally and in opposite directions. Reversing the translational movement of movable trolleys 63 is achieved by reversing the rotation of servomotor 91.

A central processing unit (not shown) controls the operation of the various actuators, particularly servomotors 81, 91 simply, precisely, and in combination, according to the variable longitudinal profile 12 of the documents and envelopes to be cut from the width of paper 10, the profile being irregular, non-cyclical, and completely controlled. This central processing unit is driven by a computer program that may or may not be associated with a signal issued by sensors that detect index marks printed on width 10 or strip 11 of paper for identifying the formats to be cut out between documents 13 and envelopes 14.

Obviously, other drive mechanisms 80, 90 may be used, the essential requirement being to displace cutting tools 60 very rapidly with great precision in a movement that combines rotation on their axes with translational movement parallel to the axis of counter-piece 70.

Actuators 81, 91 used in these drive mechanisms 80, 90 may consist of other types of motors or reduction motors, cylinders, electromagnets, or similar means. However, the use of servomotors 81, 91 offers the advantage of very precise control over motor displacement, neither start-up delays nor inertia when stopped, resulting in great deal of flexibility.

For rotational drive mechanism 80, it is preferable to provide one actuator 81 for each cutting tool 60, the cutting tools 60 being translationally movable. One actuator for every two cutting tools 60 would be complicated to implement from the standpoint of providing mechanical transmission.

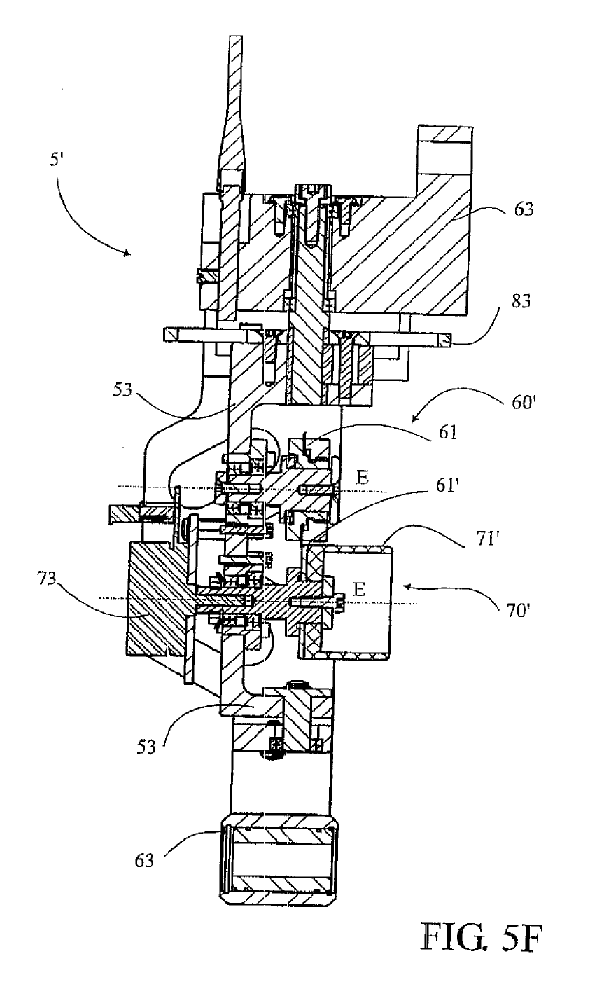

For translational drive mechanism 90, the fact that one actuator 91 is provided for each pair of cutting tools 60 ensures that both cutting tools 60 are displaced synchronously. The mechanical transmission system illustrated in FIGS. 3 and 4 may be replaced by any other equivalent system, such as the three other examples being illustrated in FIGS. 6 through 8.

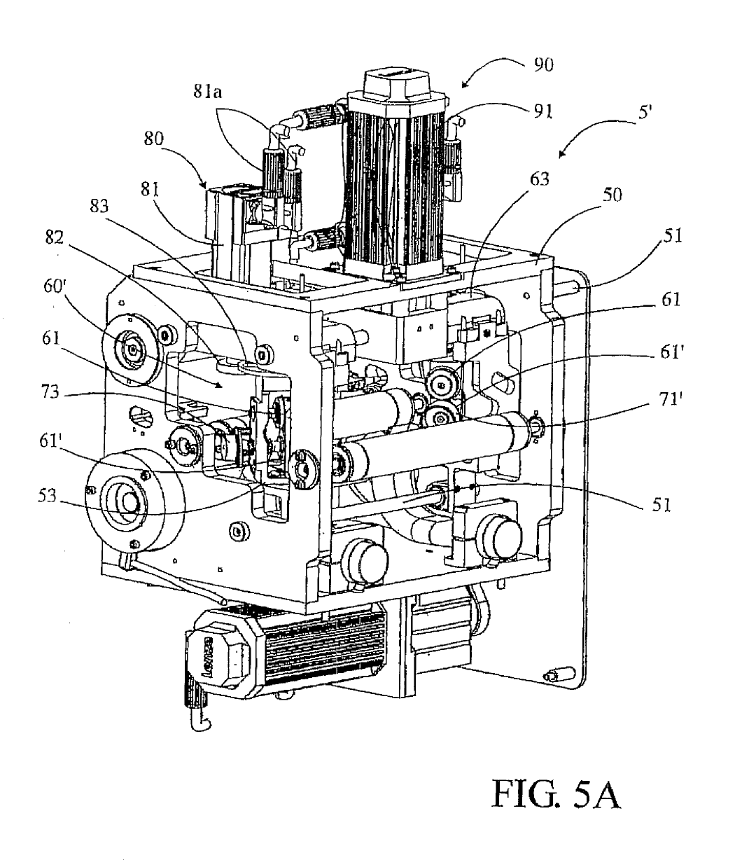

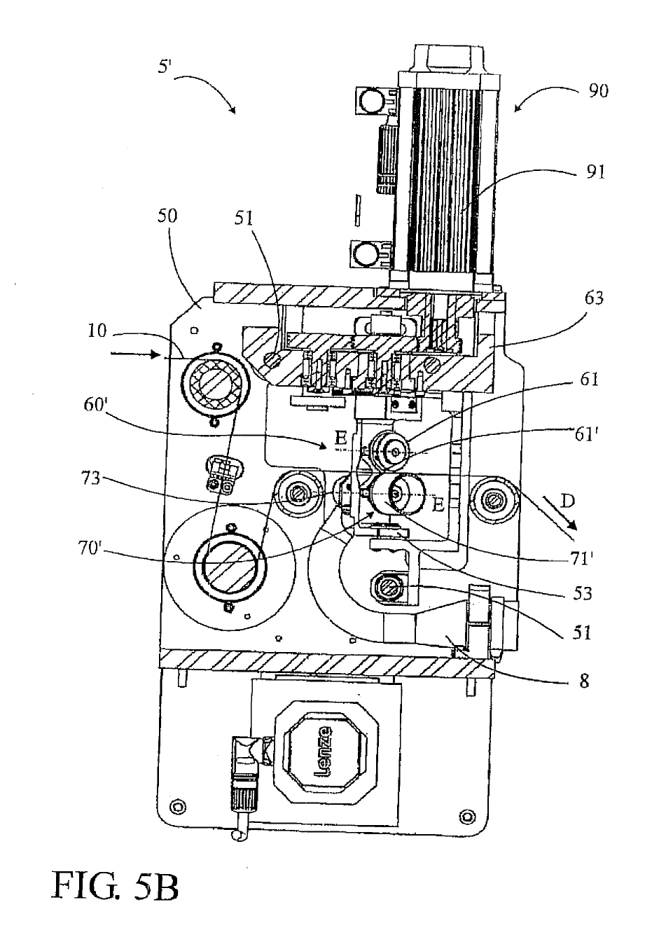

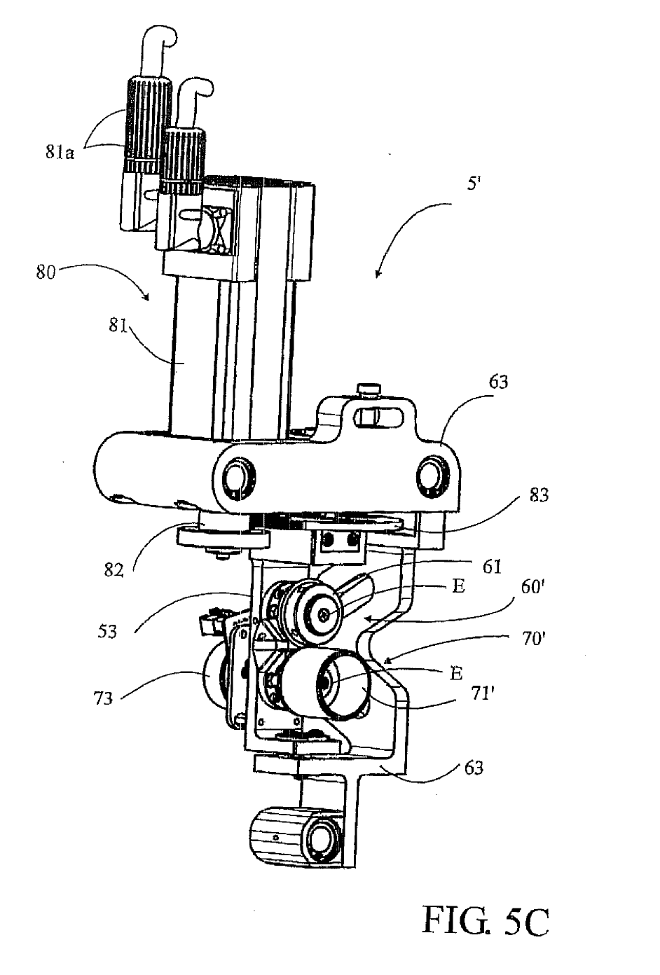

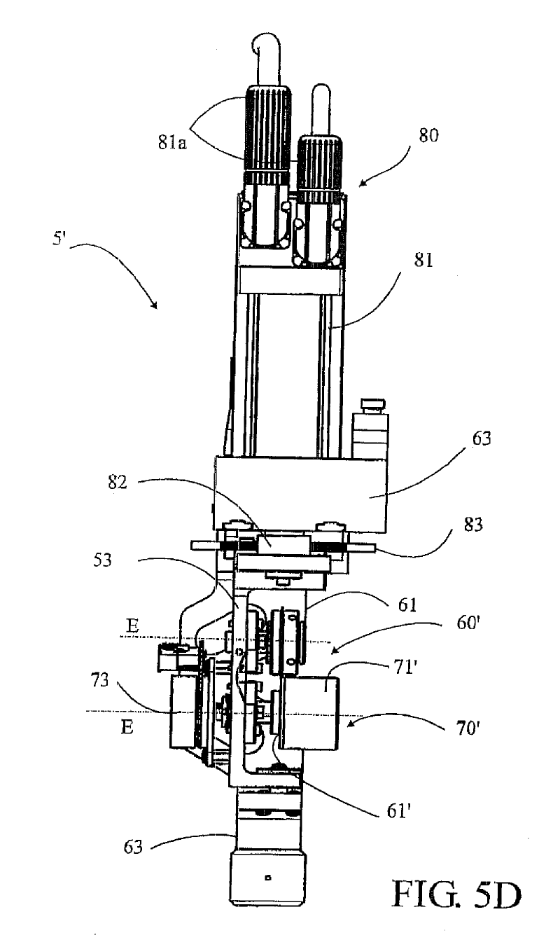

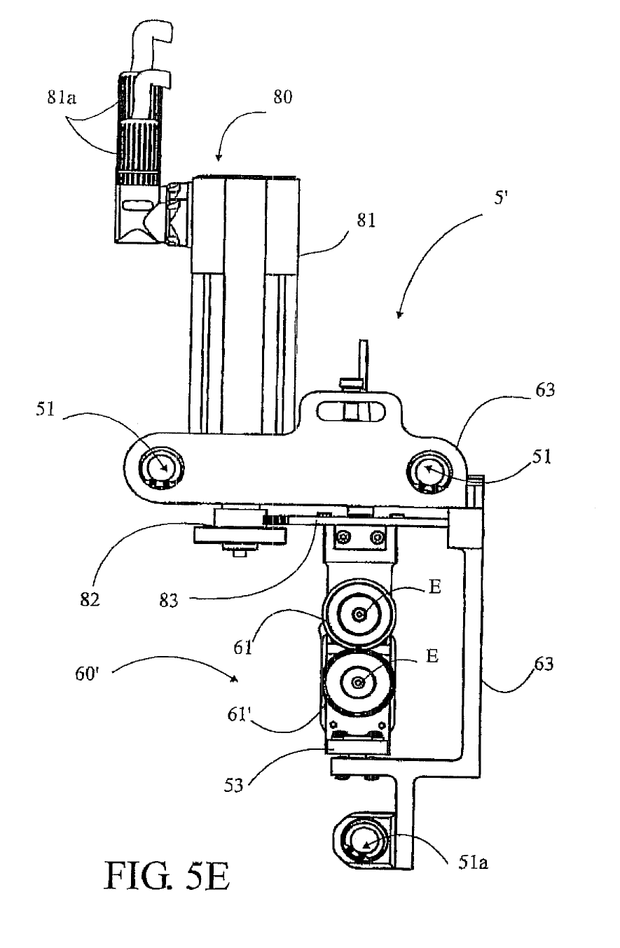

FIGS. 5A, 5B, 5C, 5D, 5E and 5F illustrate another embodiment of the cutting device 5′ according to the invention in which each cutting tool 60′ comprises a circular blade 61 and a circular counter-piece 61, these blades being tangential in the cutting zone, creating a scissor cut. In this embodiment, counter-blade 70′ comprises a roller 71′ located in the extension of counter-blade 61′ for the purpose of guiding and supporting width of material 10. The unit, formed by blade 61, counter blade 61′ and roller 71′, is held by an oscillating support 53 installed on movable trolley 63 and connected to rotational drive mechanism 80 similar to the preceding embodiment and comprising a driving or actuating servomotor 81 powered by two connecting terminals 81a. Circular blades 61 and 61′ are driven in rotation on their axis E by an actuator 73 connected to lower circular blade 61′ and roller 71′ either directly or through a mechanical transmission. Actuator 73 may be any type of motor or similar means and is supported by oscillating support 53. Rotation of cutting tools 60′ is effectuated by servomotor 81 connected to cutting tool 60′ by a small pinion motor 82 which engages a large gear 83 to form a speed reduction mechanism. Movable trolley 63 is guided in translational movement by ball bearings or the like, which slide on transverse guides 51.

In this embodiment, the pressing mechanism consisting of cylinder 65 is no longer necessary. To feed the width of material 10 through cutting device 5′, oscillating supports 53 are displaced by translational drive mechanism 90 to disengage blades 61, 61′ from the cutting zone. To initiate cutting, oscillating supports 53 are displaced in the reverse direction to engage blades 61, 61′ in the cutting zone in scissor-like fashion. This cutting device 5′ has the advantage of creating a better quality cut.

It is obvious that other tools could be used, with the essential requirement being the ability to continuously cut a strip of material into a controlled variable profile in an irregular sequence. To this end, it is possible to replace circular blades 61, 61′ with laser or ultrasound beams, high pressure liquid stream, cutting points, or the like.

In FIG. 6 the translational drive mechanism 100 comprises a mechanical transmission with an endless screw 101 with reverse threads 101a, 101b, the endless screw being guided in bearings 102, 103 and its rotation controlled by an actuator such as a motor connected to one of its extremities and not shown. Each threaded area 101a, 101b engages a screw-nut 104 provided in a movable trolley 63, with rotation of the endless screw 101 in one direction causing movable chariots 63 and cutting tools 60 to move in translation simultaneously and in opposing directions, with reverse translation being generated by reversing the direction in which the actuator rotates.

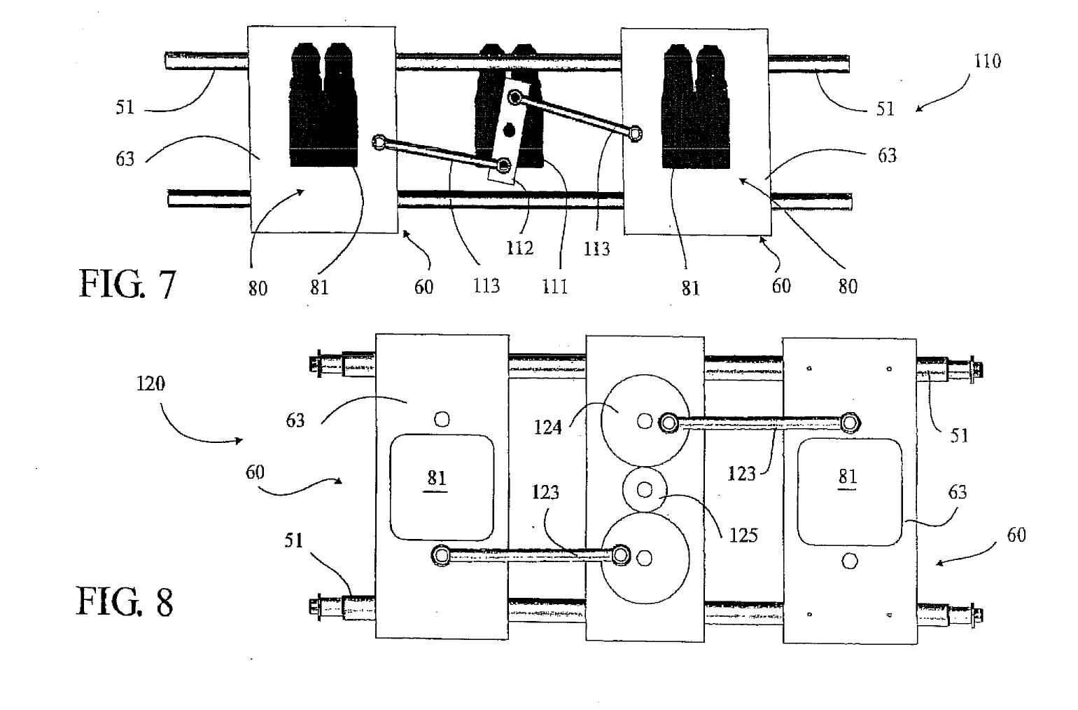

In FIG. 7 the translational drive mechanism 110 provides mechanical transmission with a rod system 112, 113. An actuator 111 such as an electric motor, a servomotor, or similar means supports on its drive shaft, a rod 112 which is connected to movable trolleys 63 via excentric rods 113, rotation of actuator 111 in one direction causing the translation of cutting tools 60 simultaneously and in opposing directions, with reverse translation being generated by reversing the direction in which actuator 111 rotates.

FIG. 8 illustrates a translational drive mechanism 120, similar to the preceding one, with the difference that rods 123 are each connected to a gear 124 engaging a common pinion motor 125. Thus, the actuator can turn in the same direction of rotation and cause the two translational movements by movable trolleys 63 simultaneously and in opposing directions, each translational movement being the result of a half-rotation by the actuator (not shown). This solution eliminates the need to stop the actuator to reverse the direction of rotation each time it is necessary to change the direction of translation.

Cutting device 10, 10′ of the invention may include a second pair of cutting tools 60, 60′ located in the axis of the first pair of cutting tools 60 or on an offset axis for cutting a second strip from a second width of material into a variable longitudinal profile, identical to or different from the first, as shown, for example, in FIG. 2B.

Possibilities for Industrial Applications:

In the examples shown in FIGS. 1 and 2, documents 13 and envelopes 15 have been printed continuously, one after the other, in the order provided for their insertion, on a width of paper 10 at a separate station using any type of printer, the width of paper 10 having been re-rolled onto a reel to supply mail preparation machine 1. Using this technique each document can be easily personalized and dedicated to an identified envelope. This mail preparation machine 1 can therefore be used for transactional mail as well as routing with no difficulty as it respects the integrity of the mail, that is, it ensures that the correct documents are placed in the correct envelope.

When the spool is placed on reel 2, the width of paper 10 is fed through the various units 3 through 7 and beyond. To allow it to progress to cutting device 5 according to FIGS. 3 and 4, circular blades 61 are raised using cylinders 65 and then cutting tools 60 are positioned relative to the printed width of paper 10. At the same time, a computer program corresponding to the strip to be cut is loaded onto a central processing unit, or a previously stored program is selected. Circular blades 61 are lowered into the working position and the machine is started. The width of paper 10 pulled by roller support system 6 moves along continuously through cutting device 5 which cuts off the longitudinal edges of the width of paper 10 according to the variable profile in an irregular sequence determined by the width of documents 13 and the width and lateral flaps 16 of envelopes 14. To form flaps 16 on envelopes 14 that are wider than documents 13, the central processing unit drives the rotational drive mechanism 80 and the translational drive mechanism 90 of cutting tools 60 simultaneously and in combination in order to displace circular blades 61 in combined rotation and translation, allowing the creation of a curved cutting line.

The mode of operation of cutting device 5′ of FIGS. 5A and 5B is similar, except that it is no longer necessary to raise and lower blades 61.

It is clearly apparent from this description that the invention attains its stated objectives with a simple, inexpensive, and adaptable cutting device, using cutting tools 60, 60′ or the like capable of generating a longitudinal cutting line in any shape at any point during the conveyance of width of paper 10, eliminating any concept of cycles, and in a controlled fashion.

The present invention is not limited to the exemplary embodiments described, but extends to any modification and variation obvious to a person skilled in the art while still remaining within the scope of protection defined in the attached claims.

1-16. (canceled)

17. A cutting device (5, 5′) for longitudinally cutting a width of continuously conveyed material (10) and for cutting at least one strip (11) into a variable longitudinal profile (12) having an irregular sequence, the cutting device (5, 5′) comprising:
at least a first pair of cutting tools (60, 60′) which cooperate with at least one counter-piece (70, 70′) disposed perpendicular to a direction at which the width of material (10) is conveyed;
at least one frame (50) on which the first pair of cutting tools (60, 60′) are supported to be movable along an axis of translation (B) that extends parallel to the counter-piece (70, 70′) for modifying an interval between each of the first pair of cutting tools (60, 60′) and along an axis of rotation (A) that is perpendicular to the counter-piece (70, 70′) for modifying a cutting angle;
each of the first pair of cutting tools (60, 60′) is connected to a translational drive mechanism (90) and a rotational drive mechanism (80), each of which are controlled in combination by at least one central processing unit, depending on a cutting line having the variable longitudinal profile (12), in a predetermined and controlled irregular sequence.

18. The cutting device according to claim 17, wherein each of the first pair of cutting tools is selected from the group consisting of laser beams, ultrasound beams, streams of water, cutting points, and circular blades.

19. The cutting device according to claim 17, wherein the cutting device further comprises a second pair of cutting tools (60, 60′) for cutting, from the same width of continuously conveyed material (10′), a second strip (11′) into a second variable longitudinal profile (12′) in a predetermined and controlled irregular sequence.

20. The cutting device according to claim 17, wherein each of the first pair of cutting tools (60, 60′) is attached to a trolley (63) for moving in translation on the frame (50) along at least one transverse guide (51), and the trolley (63) is connected to the translational drive mechanism (90).

21. The cutting device according to claim 20, wherein the rotational drive mechanism (80) comprises at least one actuator (81) located on the movable trolley (63) and connected to an associated one of the first pair of cutting tools (60, 60′).

22. The cutting device according to claim 21, wherein the actuator (81) is connected to the associated one of the first pair of cutting tools (60, 60′) via a mechanical transmission (82, 83).

23. The cutting device according to claim 17, wherein the cutting device further comprises at least one pressing mechanism (65) for displacing the first pair of cutting tools (60) between at least a raised resting position distanced from the counter-piece (70) and a lowered working position under pressure in contact the counter-piece (70).

24. The cutting device according to claim 23, wherein the pressing mechanism comprises at least one cylinder (65) located on a movable trolley (63), and the cutting tool (60) is supported by a shaft (64) of the cylinder (65) which defines the rotational axis (A).

25. The cutting device according to claim 21, wherein the cutting tool (60′) comprises a circular blade (61) and a circular counter-blade (61′) that are held tangentially by a support (53) to oscillate around the rotational axis (A) and connected to the rotational drive mechanism (80).

26. The cutting device according to claim 25, wherein the counter-piece (70′) comprises the circular counter-blade (61′) extending into a roller (71′) and driven to rotate about an blade axis (E) by an actuator (73) located on the oscillating support (53).

27. The cutting device according to claim 20, wherein the translational drive mechanism (90) comprises at least one actuator (91) common to the first pair of cutting tools (60, 60′) and connected to the movable trolleys (63) by a mechanical transmission for synchronously moving the movable trolleys (63) in reverse translation.

28. The cutting device according to claim 21, wherein the actuator (73, 81, 91) is selected from the group consisting of a motor, a reduction motor, a servomotor, a cylinder, and an electromagnet.

29. The cutting device according to claim 22, wherein the mechanical transmission is selected from the group consisting of gears (82, 83), pinions (92, 93) and racks (94), endless screws (101) with reverse threads (101a, 101b) and screw-nuts (104), rods (112, 113), gears (124, 125) and rods (123).

30. The cutting device according to claim 17, wherein the counter-piece (70) comprises at least one cylinder (71) rotating about a counter-piece axis (C).

31. The cutting device according to claim 17, wherein the cutting device further comprises at least one unit for automatic evacuation of waste generated by cutting.

32. The cutting device according to claim 31, wherein the evacuation unit comprises at least one suction nozzle (8) placed near each of the first pair of cutting tools (60, 60′) and connected to a container through a pipeline via a central suction unit.

33. A device (5, 5′) for cutting at least one strip (11) from a sheet of paper (10) as the sheet of paper (10) is unrolled from a roll of paper, the cutting device (5, 5′) comprising:
first and second cutting tools (60, 60′), the first cutting tool (60, 60′) and the second cutting tool (60, 60′), during operation, longitudinally cutting the at least one strip (11) from the sheet of paper (10) as the paper (10) is conveyed in a longitudinal direction past the first cutting tool (60, 60′) and the second cutting tool (60, 60′);
at least one counter-piece (70, 70′) is supported for communicating with the first cutting tool (60, 60′) and the second cutting tool (60, 60′) to provide a force in opposition to a cutting force, which is applied by the first cutting tool (60, 60′) and the second cutting tool (60, 60′), to longitudinally cut the at least one strip (11) from the sheet of paper (10);
at least one frame (50) supporting the first cutting tool (60, 60′) and the second cutting tool (60, 60′);
a translational drive mechanism (90) communicating with the first cutting tool (60, 60′) and the second cutting tool (60, 60′) for moving the first cutting tool (60, 60′) and the second cutting tool (60, 60′) along a translational axis (B), which extends normal to the longitudinal direction the conveyed sheet of paper (10), such that a distance between the first cutting tool (60, 60′) and the second cutting tool (60, 60′) is adjustable;
a first rotational drive mechanism (80) communicating with the first cutting tool (60, 60′) to rotate the first cutting tool (60, 60′) about a first rotational axis (A) along which the cutting force of the first cutting tool (60, 60′) is applied;
a second rotational drive mechanism (80) communicates with the second cutting tool (60, 60′) for rotating the second cutting tool (60, 60′) about a second rotational axis (A) along which the cutting force of the second cutting tool (60, 60′) is applied; and
at least one central processing unit communicating with the translational drive mechanism (90), and the first rotational drive mechanism (80) and the second rotational drive mechanism (80) controlling translational and rotational movement of the first cutting tool (60, 60′) and the second cutting tool (60, 60′) such that a longitudinal width of the at least one strip (11) is variable as the strip paper (10) is conveyed past the first cutting tool (60, 60′) and the second cutting tool (60, 60′).
